(19) United States
(12) Patent Application Publication
(10) Pub. No.: US 2008/0033906 A1
(43) Pub. Date: Feb. 7, 2008

(54) IMPROVED PERFORMANCE AND AVAILABILITY OF A DATABASE

(76) Inventor: Michael Bender, Rye Brook, NY (US)

Correspondence Address: HOFFMAN, WARNICK & D'ALESSANDRO LLC, 75 STATE ST, 14TH FLOOR, ALBANY, NY, 12207, US

(21) Appl. No.: 11/462,087

(22) Filed: Aug. 3, 2006

(51) Int. Cl. G06F 17/30

(52) U.S. Cl. 707/2

(57) ABSTRACT

The invention provides a method, system, and program product for improving the performance and/or availability of a database by controlling access to data objects within the database.

### BACKGROUND OF THE INVENTION

1. Technical Field

The invention relates generally to improving data processing systems, and more particularly, to the improvement of the performance and/or availability of a database by controlling access to data objects within the database.

2. Background Art

In data processing systems, it is desirable to make databases available to as many users as possible while also updating the contents of the databases frequently. Many data processing systems, such as those based on International Business Machine's DB2® Universal Database™ update the databases while users are querying the database. For example, Lotus Enterprise Integrator®, Websphere® Datastage®, and Business Objects Data Integrator update database tables through distributed DB2® threads. However, this makes it quite likely that a user's query of the database will interrupt, lock up, or otherwise interfere with the database update.

One solution to this problem is for a user to perform a “dirty read,” wherein a first user queries a database and uses the data objects it contains even though a second user may have altered the data object but not yet either committed to the change or rolled back the change. Thus, the first user may have queried and/or used an invalid data object. Some data processing systems may be directed to disallow dirty reads. However, this greatly decreases the performance of the system.

To this extent, a need exists for a method and system for ensuring that data objects in a database are valid while not degrading performance of the system.

### SUMMARY OF THE INVENTION

The invention provides a method, system, and program product for improving the performance and/or availability of a database by controlling access to data objects within the database.

A first aspect of the invention provides a method for increasing at least one of an availability and a performance of a database, the method comprising: defining a plurality of isolation levels for access to an object in a database, wherein at least one of the plurality of isolation levels includes a read only level; receiving from a user a request for access to the object; determining whether the user has logged onto a database system using a proper isolation level; and in the case that the user has logged onto the database system using a proper isolation level, granting to the user access to the object using the proper isolation level.

A second aspect of the invention provides a system for increasing at least one of an availability and a performance of a database, the system comprising: a system for defining a plurality of isolation levels for access to an object in a database, wherein at least one of the plurality of isolation levels includes a read only level; a system for receiving from a user a request for access to the object; and a system for determining whether the user has logged onto a database system using a proper isolation level; and a system for granting to the user access to the object using the proper isolation level.

A third aspect of the invention provides a program product stored on a computer-readable medium, which when executed, increases at least one of an availability and a performance of a database, the program product comprising: program code for defining a plurality of isolation levels for access to an object in a database, wherein at least one of the plurality of isolation levels includes a read only level; program code for receiving from a user a request for access to the object; and program code for determining whether the user has logged onto a database system using a proper isolation level; and program code for granting to the user access to the object using the proper isolation level.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a flow diagram of an illustrative method according to the invention.

FIG. 2 shows a block diagram of an illustrative system according to the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

As indicated above, the invention provides a method and system for the improvement of both the performance of a database and the control of access to a database.

In DB2®-based data processing systems, a user must be granted “SELECT” access to a data object in order to access it. According to the present invention, however, a user granted “SELECT” access may have such access modified according to a predefined isolation level, such that the user's access does not interfere with an update of the database.

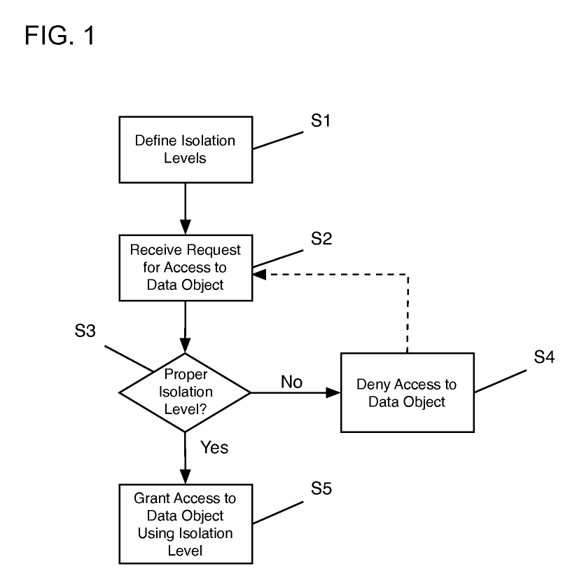

For example, referring to FIG. 1, a flow diagram of an illustrative method according to the invention is shown. At step S1, a plurality of isolation levels is defined. Such isolation levels may include, for example, a “read only” level, a “write only” level, and an “unrestricted” level. Any number of other isolation levels may be similarly defined, as will be recognized by one skilled in the art. Acceptable isolation levels may be based upon ongoing or anticipated maintenance activities of the database (e.g., updates, etc.). Accordingly, the plurality of isolation levels defined at step S1 may include levels compatible with such maintenance activities. That is, the isolation levels defined at step S1 should not, if granted to a user, interfere with such maintenance activities.

At step S2, a request for access to a data object in the database is received from a user. It should be noted that the term “user,” as used herein, may refer to an individual user as well as a group or class of users. At step S3, it is determined whether the user making the request at step S2 has logged onto the system using a proper isolation level, i.e., an isolation level that will not interfere with database maintenance activities. If not (i.e., No at step S3), the user is denied access to the data object at step S4. The user may further be issued an error message informing the user of the improper isolation level. Optionally, steps S2 through S4 may be iteratively looped, such that a user denied access to the data object at step S4 may be permitted to make another request at step S2 after logging onto the system using a different isolation level. If it is determined that the user has logged onto the system using a proper isolation level (i.e., Yes at step S3), the user may be granted access to the data object at step S5 using the isolation level chosen by the user.

It should be recognized, of course, that, as in any DB2®-based data processing system, determining whether the user has logged onto the system using a proper isolation level at step S3 also includes determining whether the user (or group, as explained above) has authority to access the database object at all (i.e., whether the user has been granted “SELECT” access). That is, if a user has not been granted “SELECT” access, the user will be denied access to the database object at step S4 regardless of the isolation level chosen by the user.

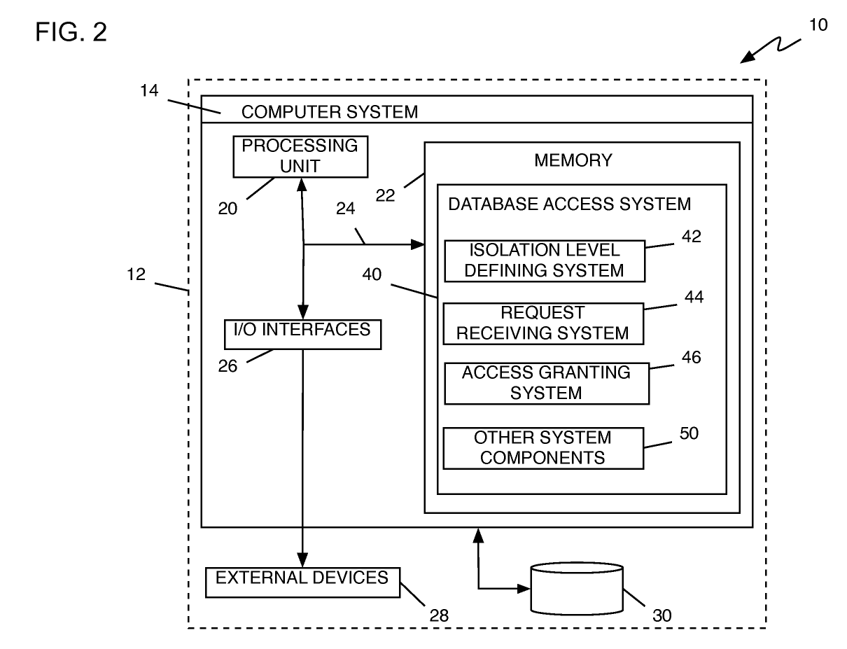

FIG. 2 shows an illustrative system 10 for improving performance and/or availability of a database. To this extent, system 10 includes a computer infrastructure 12 that can perform the various process steps described herein for improving performance and/or availability of a database. In particular, computer infrastructure 12 is shown including a computer system 14 that comprises a database access system 40, which enables computer system 14 to improve performance and/or availability of a database by performing the process steps of the invention.

Computer system 14 is shown including a processing unit 20, a memory 22, an input/output (I/O) interface 26, and a bus 24. Further, computer system 14 is shown in communication with external devices 28 and a storage system 30. As is known in the art, in general, processing unit 20 executes computer program code, such as database access system 40, that is stored in memory 22 and/or storage system 30. While executing computer program code, processing unit 20 can read and/or write data from/to memory 22, storage system 30, and/or I/O interface 26. Bus 24 provides a communication link between each of the components in computer system 14. External devices 28 can comprise any device that enables a user (not shown) to interact with computer system 14 or any device that enables computer system 14 to communicate with one or more other computer systems.

In any event, computer system 14 can comprise any general purpose computing article of manufacture capable of executing computer program code installed by a user (e.g., a personal computer, server, handheld device, etc.). However, it is understood that computer system 14 and database access system 40 are only representative of various possible computer systems that may perform the various process steps of the invention. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, database access system 40 enables computer system 14 to improve performance and/or availability of a database. To this extent, database access system 40 is shown including an isolation level defining system 42, a request receiving system 44, and an access granting system 46. Operation of each of these systems is discussed above. Database access system 40 may further include other system components 50 to provide additional or improved functionality to database access system 40. It is understood that some of the various systems shown in FIG. 2 can be implemented independently, combined, and/or stored in memory for one or more separate computer systems 14 that communicate over a network. Further, it is understood that some of the systems and/or functionality may not be implemented, or additional systems and/or functionality may be included as part of system 10.

While shown and described herein as a method and system for improving performance and/or availability of a database, it is understood that the invention further provides various alternative embodiments. For example, in one embodiment, the invention provides a computer-readable medium that includes computer program code to enable a computer infrastructure to improve performance and/or availability of a database. To this extent, the computer-readable medium includes program code, such as database access system 40, that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as memory 22 and/or storage system 30 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to improve performance and/or availability of a database as described above. In this case, the service provider can create, maintain, support, etc., a computer infrastructure, such as computer infrastructure 12, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for improving performance and/or availability of a database. In this case, a computer infrastructure, such as computer infrastructure 12, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as computer system 14, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for increasing at least one of an availability and a performance of a database, the method comprising:
defining a plurality of isolation levels for access to an object in a database, wherein at least one of the plurality of isolation levels includes a read only level;
receiving from a user a request for access to the object;
determining whether the user has logged onto a database system using a proper isolation level; and
in the case that the user has logged onto the database system using a proper isolation level, granting to the user access to the object using the proper isolation level.

2. The method of claim 1, wherein, in the case that the user has logged onto the database system using an improper isolation level, denying the user access to the object.

3. The method of claim 2, further comprising:
issuing to the user an error message.

4. The method of claim 1, wherein determining includes determining whether the user has been granted select access to the object.

5. A system for increasing at least one of an availability and a performance of a database, the system comprising:
a system for defining a plurality of isolation levels for access to an object in a database, wherein at least one of the plurality of isolation levels includes a read only level;
a system for receiving from a user a request for access to the object; and
a system for determining whether the user has logged onto a database system using a proper isolation level; and
a system for granting to the user access to the object using the proper isolation level.

6. The system of claim 5, further comprising:
a system for denying the user access to the object.

7. The system of claim 5, further comprising:
a system for issuing to the user an error message.

8. The system of claim 5, wherein the system for determining includes a system for determining whether the user has been granted select access to the object.
